(19) United States
(12) Patent Application Publication
(10) Pub. No.: US 2026/0274049 A1
(43) Pub. Date: Sep. 17, 2026

(54) Interior Fitting for a Vehicle

(71) Applicant: Illinois Tool Works Inc., Glenview, IL (US)

(72) Inventors: Günther Krämer, Enkenbach-Alsenborn (DE); Thomas Pacher, Sembach (DE)

(21) Appl. No.: 19/561,845

(22) Filed: Mar. 10, 2026

(30) Foreign Application Priority Data
Mar. 11, 2025 (DE) 10 2025 109 240.0

(51) Int. Cl. B60H 1/34; B32B 27/08; B32B 27/36; B60Q 3/225; B60Q 3/60

(52) U.S. Cl. CPC B60H 1/3421; B32B 27/08; B32B 27/365; B60Q 3/225; B60Q 3/60; B32B 2255/10; B32B 2255/205; B32B 2307/308; B32B 2307/54; B32B 2307/558; B32B 2307/714; B32B 2307/72; B32B 2605/003

(57) ABSTRACT

An interior trim part for a vehicle, such as an air vent, includes a multi-component molded structure with a first region that can be electroplated and a second region that is transparent and guides light. The transparent region is formed from a high temperature copolyester with a heat deflection temperature above 80° C. and strong resistance to chemicals that may cause stress cracking, including hand creams. The material does not accept electroplating, which allows selective plating of only the first region during a two-component injection molding process. As a result, the transparent region remains free of metal while the adjacent region receives a chrome finish. The design supports efficient manufacturing and produces a durable interior component that combines a metallic decorative appearance with integrated illumination.

### RELATED APPLICATION

The present application claims the benefit of German Patent Application No. 10 2025 109 240.0, filed Mar. 11, 2025, titled “Interior Fitting for a Vehicle,” the contents of which are hereby incorporated by reference.

### BACKGROUND

In the vehicle interior, decorative elements are increasingly being used that fulfill both aesthetic and functional purposes. A current trend in automotive design is the combination of high-quality-appearing, metallized surfaces, for example, in a chrome appearance, with backlit, or transilluminated, regions. Such combinations make it possible to render functional operating elements visible in the dark and, at the same time, to create an appealing ambience. These components are often produced as multi-component molded parts by an injection molding method, wherein a first material is used for the region to be electroplated later, and a second, transparent material is used for the light-guiding region.

As a transparent material for such applications, polycarbonate (PC) is usually used. Polycarbonate may be processed well, in two-component injection molding, with common electroplatable plastics, such as acrylonitrile-butadiene-styrene copolymers (ABS), or polymer blends of PC and ABS (PC-ABS). It has high transparency and good mechanical properties.

However, the known solutions from the prior art have significant disadvantages. A substantial disadvantage of polycarbonate is its inadequate chemical resistance, in particular, to substances that frequently occur on human skin. Contact with hand creams, sunscreens, or other cosmetics leads, in polycarbonate, to stress cracking corrosion, which renders the material brittle, leads to cracks, and impairs its optical as well as mechanical properties.

Since the relevant interior trim parts, such as air vents or operating elements, are, as intended, touched by the vehicle occupants, this disadvantage is particularly serious and leads to a shortened service life and an inferior perceived quality of the component.

Other transparent standard materials that could exhibit better chemical resistance often bond only poorly to the PC-ABS material intended for electroplating or are likewise coated with a metal layer during the electroplating process, whereby their transparency is lost.

Attempts have already been made using other copolyesters that, although not electroplatable, exhibit an insufficient heat deflection temperature for use in the vehicle interior. A vehicle interior may heat up to over 80° C. under solar irradiation, which may lead to deformation of components made of plastics that are thermally insufficiently stable.

Thus, in the prior art, there is no material that simultaneously fulfills the requirements of chemical resistance, high heat deflection temperature, processability in two-component injection molding with PC-ABS, and non-electroplatability.

### SUMMARY OF THE DISCLOSURE

The present disclosure relates generally to a vehicle air vent, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 illustrates a perspective view of an embodiment of a vehicle air vent according to the disclosure.

FIG. 2 illustrates a perspective sectional view of the air vent from FIG. 1.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples, and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to interior trim parts for vehicles and, in particular, to a method for producing same, and to the use thereof.

In particular, the disclosure relates to decorative molded parts that are used in regions of the vehicle interior that may be touched by occupants and that are simultaneously configured for illumination or light-guiding functions. A typical example of such an interior trim part is an air vent, or a decorative bezel, in the center console, or the instrument panel, of a vehicle.

The disclosure is based on the object of specifying an interior trim part for a vehicle, a method for producing same, and a corresponding use, which overcome the disadvantages of the prior art.

In particular, an interior trim part is to be created that exhibits high resistance to chemical influences, such as hand cream, is, at the same time, suitable for sophisticated light-design applications, and may be produced cost-effectively in a multi-component composite having electroplated surfaces.

In one example, an interior trim part for a vehicle, for example, includes an air vent, which comprises a decorative molded part. This molded part is formed, at least partially, of a transparent material that may guide and decouple light.

According to the disclosure, this transparent material is, at least in regions, a high temperature copolyester material.

The use of a copolyester material solves the fundamental problem of the inadequate chemical resistance of polycarbonate. Copolyesters are known to be insensitive to the chemicals contained in hand creams and cosmetics, whereby the durability and the aesthetic quality of the component are ensured over the entire service life of the vehicle.

The feature “high temperature” ensures, in this context, that the material also withstands the demanding thermal conditions in the vehicle interior without deforming or losing its mechanical properties. This is a decisive advantage over other copolyesters that, although chemically resistant, are not thermally stable enough. By this specific material selection, for the first time, a transparent material is provided for touchable, illuminated vehicle interior parts that are robust both chemically and thermally.

Preferably, the copolyester material of the molded part is to exhibit the properties of polycarbonate, wherein polycarbonate, in comparison with the copolyester material, does not exhibit the necessary and/or required chemical resistance, which is required, in particular, because it cannot be avoided that the surface of the molded part is manually touched by an operator, as a consequence of which, in particular, it cannot be avoided that residues of hand creams or the like remain on the molded part.

The copolyester material of the type disclosed herein, in contrast, exhibits optimized chemical resistance in comparison with polycarbonate.

In particular, the copolyester material of the molded part is formed such that the copolyester material, in particular, due to its chemical properties, is not coatable by means of a chromium-III plastic electroplating technique.

In summary, it is to be noted that the copolyester material of the molded part exhibits improved chemical resistance with respect to polycarbonate, in particular, with respect to stress cracking corrosion.

According to implementations of the interior trim part according to the disclosure, the interior trim part comprises, in particular, a decorative molded part made of a polymer blend of ABS and polycarbonate, and wherein, in particular, by over-molding, at least partially or in regions, at least one additional plastic layer of a high-temperature copolyester material is added to the molded part.

In particular, the molded part of the interior trim part according to the disclosure, such as, for example, an air vent for the interior of a vehicle, is produced by two-component injection molding, also called overmolding. This is an injection-molding method in which additional plastic layers are added to an existing mold-ed part in order to achieve a combination of properties that would not be possible with a single material.

In the present case, this is a combination of a polymer blend of ABS and polycarbonate (PC) and a high temperature copolyester material. This combination of the polymer blend of ABS and polycarbonate and the high-temperature copolyester material exhibits excellent properties, in particular, chemical resistance, good transparency and high gloss, good resistance to scratches, and, in particular, thermal resistance, which is a substantial point when the decorative molded part is part of an air vent.

In addition, the combination of the polymer blend of ABS and polycarbonate and the high temperature copolyester material provides the decisive advantage that the molded part is part of an illumination device, for example, of the air vent. In this context, it was recognized that, in an easily implementable manner, the polymer blend of ABS and polycarbonate may be electroplated and/or chrome-plated in order to render the region of the molded part opaque to light, while the region where the high-temperature copolyester material is added remains transluminal (transparent).

In the development of the present disclosure, various polymer materials and mate-rial combinations were examined. However, the polymer materials currently known and usually used generally do not fulfill the high requirements, above all, with respect to their mechanical properties, their surface properties, their aging behavior, and their emission and/or odor behavior, which are required for use in air vents.

Molded parts made of polymer materials that are used, in particular, in the interior of motor vehicles must satisfy high requirements, above all, with respect to their mechanical properties, their surface properties, their aging behavior, and their emission and/or odor behavior. For producing molded parts for motor-vehicle body and interior applications, various polymer materials have been used to date. One material used is ABS. This material exhibits poor UV resistance, poor heat-aging resistance, and poor heat deflection temperature (Vicat B softening temperature below 110° C.).

A further material used is ABS/PC (polymer blend of acrylonitrile-butadiene-styrene copolymer and polycarbonate). However, this material exhibits only inadequate UV resistance, poor heat-aging behavior (toughness and elongation at break after heat storage), poor stress-cracking resistance, for example, to plasticizers, poor flowability, and, in particular, poor emission properties and poor odor behavior.

Odor behavior is understood to mean the tendency of materials, after temperature and climate storage of a stipulated duration, to release volatile constituents that have a perceptible odor.

As a further material, ABS/PA (polymer blend of ABS and polyamide) is used. ABS/PA also exhibits poor UV resistance, poor heat deflection temperature (Vicat B softening temperature<110° C.), poor heat-aging resistance, low dimensional stability due to high moisture absorption, and poor flowability.

As a further material, PPE/HIPS (polymer blend of polyphenylene oxide and impact-modified polystyrene) is used. Disadvantages of this material are its poor flowability, poor UV resistance, foam adhesion and heat-aging resistance, and its poor odor behavior.

Furthermore, PET/PC (polymer blend of polyethylene terephthalate and polycarbonate) is used. Disadvantages of this material are its low stress-cracking resistance, for example, to plasticizers, and its poor flowability.

PBT/PC, as a further material used, also exhibits poor flowability and stress-cracking resistance.

The above-mentioned materials predominantly exhibit only poor heat deflection temperature and poor heat-aging resistance. Good heat deflection temperature and heat-aging resistance of the materials used are, however, essential, since the components of an air vent may heat up considerably, in particular, in the case of rapid heating of the motor-vehicle interior.

Existing materials also exhibit deficiencies for exterior applications. Thus, blends of PPE and PA are distinguished by poor dimensional stability as a result of water absorption and by poor processability.

The abovementioned disadvantages could be remedied using polymer materials on the basis of PBT/ASA/PSAN (polymer blends of polybutylene terephthalate, acrylonitrile-styrene-acrylic ester copolymer, and polystyrene-acrylonitrile copolymer). Such materials are disclosed generally in DE-A 39 11 828. The exemplary embodiments relate to molding compounds having a high acrylonitrile content of the PSAN copolymers. Molded parts from these molding compounds, however, like the predominant number of the abovementioned materials, exhibit poor emission and odor behavior.

Moreover, these polymer materials are disadvantageous during processing by injection-molding technique. In the injection-molding technique, the freshly produced molded bodies, for example, due to incomplete crystallization, exhibit increased adhesion to the mold walls in the injection molds. Due to this increased adhesion, it is necessary to provide the surfaces of the injection molds with corresponding anti-adhesion agents such that the cycle times of the individual injection-molding operations are not necessarily prolonged due to the adhesion tendency of the molding compound.

Another possibility for keeping the cycle time as low as possible is to add anti-adhesion agents to the molding compound itself. However, both the use of anti-adhesion agents in the injection mold and in the molding compound itself usually leads to undesired deposits forming on the surface of the injection mold, which, for example, adversely influence the surface of the molded part.

The cycle time is defined as the time period between the injection of the molding-compound melt and the demolding of the injection-molded part. The length of the cycle time has a direct effect on the quantity per injection-molding system and thus on the cost of the injection-molded part. Although the adhesion tendency of the molding compound may be counteracted by cooling the injection molds, this is associated, on the one hand, with high technical effort. On the one hand, however, this involves a great deal of technical effort. Furthermore, cooling re-peated in each cycle over a large number of cycles leads to faster material fatigue of the injection mold due to the associated temperature fluctuations, which then must be replaced more frequently.

In a surprising manner, however, the combination according to the disclosure of a polymer blend of ABS and polycarbonate and a high-temperature copolyester material exhibits excellent properties, in particular, with respect to optimal heat deflection temperature, heat-aging resistance, UV resistance, stress-cracking resistance, flowability, and dimensional stability. Processing by injection-molding technique is also possible without problems.

With respect to the high temperature copolyester material, this should exhibit, according to ISO 1183 (version as of the filing date), a density between 1.15 g/cm3 and 1.20 g/cm3. A tensile modulus measured according to ISO 527 (version as of the filing date) should preferably be in a range of about 1610 MPa to about 1635 MPa, and preferably in a range of about 1620 MPa to about 1630 MPa.

According to preferred implementations of the interior trim part according to the disclosure, the Charpy notched impact strength measured according to ISO 179-1eA (version as of the filing date) at 23° C. is in a range of about 70 kJ/m2 to about 80 kJ/m2, and preferably in a range of about 75 kJ/m2 to about 77 kJ/m2.

In particular, the high temperature copolyester material exhibits a heat deflection temperature measured according to ISO 75 (version as of the filing date) at 1.8 MPa of about 80° C. to about 90° C., and preferably of about 85° C. to about 86° C. The Vicat softening temperature (50 N, 50° C./h) measured according to ISO 306 (version as of the filing date) should be in a range of about 105° C. to about 117° C., and preferably in a range of about 110° C. to about 114° C.

In implementations of the interior trim part according to the disclosure, with respect to the high-temperature copolyester material, it is provided that this exhibits a melt volume rate (260° C./5 kg) measured according to ISO 1133 (version as of the filing date) of about 10 g/10 minutes to about 16 g/10 minutes, and preferably of about 12 g/10 minutes to about 14 g/10 minutes.

In order to be able to use the interior trim part according to the disclosure as a component in an illumination complex, it is provided, in particular, that the molded part, in regions in which the at least one additional plastic layer of the high-temperature copolyester material is not added, is provided, at least partially or in regions, with an electroplating layer formed by, in particular, a decorative electro-plating technique (in particular, a chromium layer).

In particular, in this context, provision is made that the molded part, in the region in which the at least one additional plastic layer comprising the high-temperature copolyester material is added, is provided, at least partially or regionally, and preferably completely, without a coating layer formed, in particular, by a decorative electroplating technique (electroplated chromium layer) and, in particular, also without a translucent layer.

Preferably, the high temperature copolyester material exhibits a light transmittance measured according to ISO 13468-2 (version as of the filing date) of at least 90%/2 mm, and preferably a light transmittance of about 92%/2 mm.

Thus, the interior trim part is suitable, in particular, as part of an illumination solution for the interior of the vehicle. Accordingly, in embodiments of the interior trim part according to the disclosure, provision is made that at least one light source, in particular, in the form of an LED, is assigned to the interior trim part, or that the interior trim part comprises at least one light source, in particular, in the form of an LED, wherein the molded part comprises a light incoupling region via which light emitted by the at least one light source is couplable into or is coupled into the molded body, and wherein the molded part comprises at least one light outcoupling region via which the light previously coupled into the molded body is at least partially couplable out of the molded body. In this context, the light out-coupling region is configured, at least partially or regionally, and preferably exclusively, only in the region in which the at least one additional plastic layer comprising the high-temperature copolyester material is added.

As the high temperature copolyester material, in particular, a copolyester material is suitable which was developed by the company EASTMAN and is designated, at least internally at EASTMAN, as D44223. As an alternative thereto, the copolyester material marketed by the company EASTMAN under the designation “Tritan” is also suitable.

In another example, a method for producing such a multi-component interior trim part comprises providing a first, electroplatable component and injection-molding a second, transparent component by two-component injection molding.

The core of the method according to the disclosure resides in that, for the second component, a high temperature copolyester material is used that exhibits a heat deflection temperature (HDT) of at least 80° C. and is not electroplatable.

This method enables economical production of a highly integrated component in a single injection-molding process. The targeted selection of a non-electroplatable transparent material renders complex masking steps before electroplating superfluous, which increases process reliability and reduces costs. The defined minimum heat deflection temperature ensures that the finished component fulfills the high-quality requirements of the automotive industry and does not warp in the event of temperature fluctuations.

In an example, a multi-component interior trim part. It comprises a first, electroplatable region having a decorative electroplated surface and a second, transparent region connected thereto.

According to the disclosure, the second region is formed of a high temperature copolyester material that exhibits improved chemical resistance relative to polycarbonate and a heat deflection temperature (HDT) of at least 80° C. The combination of the two regions in a single component creates a seamless appearance without joints or gaps, which produces a high-quality appearance. The specific material combination, an electroplatable material for the chrome appearance and the copolyester according to the disclosure for transparency and robustness, provides the technical solution to the previously unsolved problem of combining aesthetics, functionality, and durability in a touchable, illuminated decorative element.

Disclosed is the use of a high temperature copolyester material for producing a transparent, touchable region of an interior trim part. The use is wherein the region exhibits a heat deflection temperature (HDT) of at least 80° C. and resistance to stress cracking corrosion induced by hand cream or sunscreen.

Disclosed is the use of the material to solve a specific technical problem, which resides in having recognized that precisely this material class having this specific property profile is the solution to a long-standing problem in the automotive industry.

According to an example, it is provided that the copolyester material of the molded part is configured such that it, in particular, due to its chemical properties, is not coatable using a chromium-III plastic electroplating technique.

This provides the decisive process-technology advantage that, during production of a multi-component component, complex masking or covering steps before the electroplating process may be omitted. The selective non-coatability of the copolyester ensures that only the regions provided therefore are metallized, while the transparent regions reliably remain transparent. This leads to a significant reduction in the reject rate, a simplification of the manufacturing process, and thus to a considerable cost saving.

According to another example, the copolyester material of the molded part exhibits chemical resistance improved with respect to polycarbonate, in particular, with respect to stress cracking corrosion.

This advantage is of central importance for the application in the vehicle interior, since it directly influences the service life and the optical quality of the component. The improved resistance prevents the formation of microcracks, embrittlement, or clouding of the material upon contact with everyday substances. This ensures a permanently high-quality perceived quality and haptics of the interior element and increases the perceived quality of the entire vehicle.

According to another example, it is provided that the decorative molded part comprises a region of a polymer blend of ABS and polycarbonate, wherein, by overmolding, an additional plastic layer of the high temperature copolyester material is added to the molded part.

This configuration describes the preferred technical implementation as a two-component component. It enables combination of the established advantages of PC-ABS, such as good electroplatability and mechanical stability, with the advantages of the copolyester according to the disclosure. By the overmolding method, a monolithic composite is formed that is free of gaps and exhibits high structural integrity.

According to implementations of the disclosure, it is provided that the high temperature copolyester material exhibits a density measured according to ISO 1183 between 1.15 g/cm³ and 1.20 g/cm³.

Defining this density range contributes to precise characterization of the suitable material and ensures reproducibility of the disclosure. A defined density is also relevant for weight calculation of the component, which is of importance in the automotive industry with respect to efficiency and weight reduction. It further delimits the material according to the disclosure from other unsuitable plastics.

According to another example, the high temperature copolyester material has a tensile modulus measured according to ISO 527 of about 1,610 MPa to about 1,635 MPa.

A tensile modulus in this specific range ensures that the material has the required stiffness and dimensional stability for use as a structural or decorative element. It prevents the component from bending or deforming excessively under mechanical load, for example, during actuation. This property is decisive for high-quality haptics and reliable function of the component over its service life.

According to another example, the high-temperature copolyester material exhibits a Charpy notched impact strength measured according to ISO 179-1eA at 23° C. of about 70 kJ/m² to about 80 kJ/m².

This high notched impact strength imparts excellent resistance of the component to impacts and blows, as may occur in everyday vehicle use. It prevents the component from breaking or splintering in the event of an impact, which is advantageous both for durability and for occupant safety. The material remains robust and tough even under sudden loading. The material remains robust and tough even under sudden loading.

In another example, the high temperature copolyester material exhibits a heat deflection temperature measured according to ISO 75 at 1.8 MPa of about 80° C. to about 90° C.

This is one of the core features of the disclosure that establishes superiority over other copolyesters. An HDT in this range guarantees that the component remains dimensionally stable even in the case of extreme heat development in the vehicle interior, for example, due to direct solar irradiation in summer. This prevents warpage, deformation, and loss of fit, which is essential for functionality and aesthetics of interior components.

According to implementations of the disclosure, it is provided that the high temperature copolyester material exhibits a Vicat softening temperature measured according to ISO 306 of about 105° C. to about 117° C. The Vicat softening temperature supplements the HDT and further defines the upper temperature operating range of the material.

A value in this range ensures that the material does not soften even under local pressure loading at elevated temperatures. This is important for scratch resistance and resistance to impressions on the surface.

According to another example, the high temperature copolyester material exhibits a melt volume rate measured according to ISO 1133 of about 10 g/10 min to about 16 g/10 min.

A melt volume rate in this range ensures excellent processability in the injection-molding process. It enables complete and precise filling even of complex and delicate tool geometries, which is required for modern configurations of decorative bezels and air vents. This ensures high surface quality and dimensionally accurate reproduction of fine structures.

According to another example, the molded part is provided, in regions in which the copolyester layer is not present, with a decorative electroplating layer. This describes the final configuration of the multi-component component in which the desired chrome appearance is implemented.

This combination of a high-gloss, metallic surface and a highly transparent, illuminated region produces the desired high-quality and modern visual impression. The electroplating layer also protects the underlying PC-ABS material.

In an alternative example, the molded part, in the region of the copolyester layer, is configured completely without an electroplating layer.

It is contemplated that an advantage is the clean separation between the metallized and the non-metallized, transparent region. This constitutes the prerequisite for clear and undisturbed light guidance and light outcoupling.

According to implementations of the disclosure, it is provided, that the high temperature copolyester material exhibits a light transmittance measured according to ISO 13468-2 of at least 90%/2 mm.

Such high light transmittance is the basis for brilliant and efficient illumination solutions. It enables use of lower-power, and thus more energy-efficient, LEDs, since very little light is absorbed in the material. In addition, uniform and color-true light distribution without undesired clouding or discoloration is ensured.

In another example, at least one light source, such as an LED, is assigned to the interior trim part, and the molded part comprises light incoupling regions and light outcoupling regions.

This configuration describes functional integration of the molded part into an illumination system. The clear definition of incoupling and outcoupling regions enables a targeted light design, wherein light is directed precisely to where it is required for ambient lighting and/or functional lighting. This increases design freedom and functionality of the component.

In another example, the interior trim part is configured as a vehicle air vent having a housing and a movable or stationary component for influencing the air flow. The application in an air vent is particularly demanding, since mechanical movement, haptic requirements, thermal loading, and aesthetic requirements come together here. The disclosure solves precisely the specific material problems that arise in modern, illuminated air vents.

In another example, the air vent furthermore comprises an illumination device for illuminating the component. This completes the functional system of an illuminated air vent. The illumination may serve to indicate the position or setting of the air guide vanes in the dark, which increases operating safety. Alternatively, or additionally, it may serve as part of the ambient-light concept of the vehicle and increase the feeling of luxury and modernity.

In summary, it is to be noted that the core of the disclosure resides in the targeted material selection for touchable and, at the same time, illuminated interior trim parts in vehicles, such as, for example, air vents or decorative bezels.

Instead of the polycarbonate usually used, but chemically susceptible, a specific high temperature copolyester material is used. The decisive advantage of this material selection is solving a fundamental conflict of objectives. The copolyester material provides outstanding chemical resistance, in particular, to the substances contained in hand creams or sunscreens, whereby stress cracking corrosion, embrittlement, and optical impairments over the entire service life of the vehicle are avoided.

A further substantial aspect is the high thermal stability of the selected copolyester, which is defined by a heat deflection temperature (HDT) greater than 80° C. This property distinguishes the material according to the disclosure from other copolyesters and is essential for use in the vehicle interior. It guarantees that the component remains dimensionally stable even in the case of strong solar irradiation and the associated high temperatures and does not warp. This advantage ensures the fit accuracy, functionality, and permanently high-quality perceived quality of the component under all climatic conditions.

The disclosure unfolds its full potential in the production of multi-component components in which a transparent, light-guiding component is combined with an electroplated, that is, chrome-plated, component. The high-temperature copolyester material according to the disclosure is, in this context, bonded, in two-component injection molding, to an electroplatable plastic, such as a PC-ABS blend.

The major process-technology advantage resides in that, due to its chemical structure, the copolyester does not accept a metal layer during the electroplating process. This enables a greatly simplified and more cost-effective manufacturing process, since complex covering or masking steps before chrome plating may be omitted, which increases process reliability and reduces reject rates.

As a result, a highly integrated component is produced that, optically, appears as if made in one piece and that perfectly combines the advantages of both materials. It combines a brilliant, decorative chromium surface with a highly transparent region for effective backlighting or ambient lighting. The high light transmission of the copolyester of over 90% ensures clear, bright, and energy-efficient light guidance. At the same time, due to the robustness of the copolyester, the overall component is resistant to scratches, impacts, and the chemical influences already mentioned.

In summary, the disclosure thus enables production of a new generation of vehicle interior parts that satisfy the highest aesthetic demands for modern configurations and, at the same time, exhibit previously unattained durability and robustness in daily use. By intelligent combination of material properties and manufacturing methods, a durable, functional, and high-quality product is created that increases the perceived quality of the entire vehicle interior.

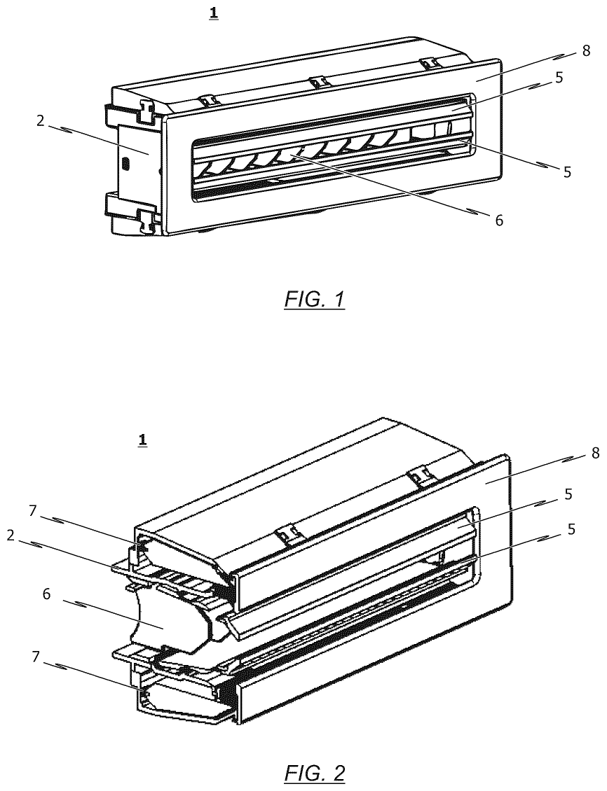

FIG. 1 shows a perspective view of an embodiment of an air vent according to the disclosure. The air vent 1 configured as an interior trim part for a vehicle comprises a housing 2, which forms the basic structure of the component.

On the side facing the vehicle interior, a decorative bezel 8 is provided, which represents the visible frame of the air vent 1. Within the opening of the bezel 8, air guide elements are arranged, which serve to guide and influence the air flow emerging from the air vent 1. In the illustrated exemplary embodiment, these comprise stationary components 5, which may be configured as air guide shells, as well as a movable component 6, which is configured as a pivotable air guide vane. The stationary components 5 and the movable component 6 together form the decorative molded part, which is manufactured from the transparent high temperature copolyester material according to the disclosure in order to enable backlighting.

By actuating the movable component 6, the user may control the orientation of the air flow, for example, in the vertical direction, while the stationary components 5 may divide or guide the air flow in another direction, for example, horizontally.

FIG. 2 shows a perspective sectional view of the air vent from FIG. 1, which illustrates the internal structure of the component. In this illustration, it is apparent how the individual elements of the air vent 1 interact.

The housing 2 encloses the internal functional components and forms an air channel through which the air flows. The bezel 8 forms the external, visible termination. The stationary components 5 and the movable component 6 are arranged in the interior of the housing 2. Decisive in this view is the illustration of the light source 7.

The light source 7, preferably one or more LEDs, is arranged in a fixed position in the housing 2. It is positioned such that it couples light into the components 5 and 6 manufactured from the transparent material. The light emitted by the light source 7 is received by the transparent material, guided through same, and decoupled out again at the surfaces visible to the viewer.

In this manner, indirect and homogeneous illumination of the air guide elements is achieved, which fulfills both functional (visibility in the dark) and aesthetic (ambient lighting) purposes. The arrangement illustrates the principle of light guidance within the decorative molded part formed by the components 5 and 6.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE SIGNS

1 Air Vent
2 Housing
5 Stationary Component and/or Air Guide Shell
6 Movable Component Or Air Guide Vane
7 Light Source
8 Bezel

What is claimed is:

1. An interior trim part for a vehicle, wherein the interior trim part is configured as an air vent (1), and wherein the interior trim part comprises an decorative molded part that is formed completely or at least partially or in regions of a transparent material, wherein the transparent material of the molded part is configured to, at least as needed, decouple at least a portion of light coupled into the molded part or into the material of the molded part in a manner at least indirectly perceptible in the interior of the vehicle into the interior of the vehicle, wherein the transparent material of the molded part is formed, at least partially or in regions, of a copolyester material and of a high-temperature copolyester material.

2. The interior trim part according to claim 1,
wherein the copolyester material of the molded part is configured such that the copolyester material is not coatable using a chromium-III plastic electroplating technique.

3. The interior trim part according to claim 1,
wherein the copolyester material of the molded part exhibits chemical resistance improved with respect to polycarbonate with respect to stress cracking corrosion.

4. The interior trim part according to claim 1,
wherein the decorative molded part of the interior trim part comprises a region of a polymer blend of ABS and polycarbonate, wherein at least partially or in regions, at least one additional plastic layer of the copolyester material configured as a high temperature copolyester material is added to the region of the molded part.

5. The interior trim part according to claim 1,
wherein the copolyester material configured as a high temperature copolyester material exhibits a density measured according to ISO 1183 (version as of the filing date) between 1.15 g/cm³ and 1.20 g/cm³.

6. The interior trim part according to claim 1,
wherein the copolyester material configured as a high temperature copolyester material exhibits a tensile modulus measured according to ISO 527 (version as of the filing date) of about 1,610 MPa to about 1,635 MPa.

7. The interior trim part according to claim 1,
wherein the copolyester material configured as a high-temperature copolyester material exhibits a Charpy notched impact strength measured according to ISO 179-1eA (version as of the filing date) at 23° C. of about 70 kJ/m² to about 80 kJ/m².

8. The interior trim part according to claim 1,
wherein the copolyester material configured as a high temperature copolyester material exhibits a heat deflection temperature measured according to ISO 75 (version as of the filing date) at 1.8 MPa of about 80° C. to about 90° C.

9. The interior trim part according to claim 1,
wherein the copolyester material configured as a high temperature copolyester material exhibits a Vicat softening temperature (50 N, 50° C/h) measured according to ISO 306 (version as of the filing date) of about 105° C. to about 117° C.

10. The interior trim part according to claim 1,
wherein the copolyester material configured as a high temperature copolyester material exhibits a melt volume rate (260° C./5 kg) measured according to ISO 1133 (version as of the filing date) of about 10 g/10 min to about 16 g/10 min.

11. The interior trim part according to claim 1,
wherein the molded part, in regions in which the at least one additional plastic layer of the copolyester material configured as a high temperature copolyester material is not added, is provided, at least partially or in regions, with an electroplating layer formed by a decorative electroplating technique.

12. The interior trim part according to claim 1,
wherein the molded part, in the region in which the at least one additional plastic layer of the copolyester material configured as a high temperature copolyester material is added, is provided, at least partially or in regions, without an electroplating layer formed by a decorative electroplating technique.

13. The interior trim part according to claim 1,
wherein the copolyester material configured as a high temperature copolyester material exhibits a light transmittance measured according to ISO 13468-2 (version as of the filing date) of at least 90%/2 mm and a light transmittance of about 92%/2 mm.

14. The interior trim part according to claim 13, wherein at least one light source (7) in the form of an LED, is assigned to the interior trim part, or wherein the interior trim part comprises at least one light source (7) in the form of an LED, wherein the molded part comprises at least one light incoupling region via which light emitted by the at least one light source (7) is couplable into or is coupled into the molded body, and wherein the molded part comprises at least one light outcoupling region via which the light previously coupled into the molded body is at least partially couplable out of the molded body, wherein the light outcoupling region is configured, at least partially or regionally, only in the region in which the at least one additional plastic layer comprising the copolyester material configured as a high-temperature copolyester material, is added.

15. The interior trim part according to claim 1, wherein the interior trim part is configured as a vehicle air vent (1), comprising:
a housing (2) having an air inlet region and an air outlet region opposite thereto; and
at least one component (5, 6) that is movable relative to the housing (2) or stationary relative to the housing (2), which is arranged, at least in regions, in an air channel or air-channel system in the housing (2) of the air vent (1) or arranged in the air outlet region of the air vent (1) and configured at least as needed, to influence an air flow discharged or to be discharged from the air outlet region with respect to an orientation and/or with respect to a volume flow,
wherein the decorative molded part of the interior trim part is formed by the at least one component (5, 6) of the vehicle air vent (1) that is movable relative to the housing (2) or stationary relative to the housing (2).

16. The interior trim part according to claim 15,
wherein the air vent (1) further comprises an illumination device for at least partially or in regions indirectly illuminating the at least one component (5, 6), wherein the illumination device comprises at least one light source (7), arranged in a fixed position relative to the housing (2) of the air vent (1) in the form of an LED.

17. A method for producing a multi-component interior trim part for a vehicle according to claim 1, comprising the steps:
providing a first component (5, 6) of a first polymer material that is electroplatable;
injection-molding a second component (5, 6) of a second, transparent polymer material onto the first component (5, 6) by two-component injection molding,
wherein
the second polymer material is a high temperature copolyester material that exhibits a heat deflection temperature (HDT) at 1.8 MPa according to ISO 75 of at least 80° C. and that, due to its chemical properties, is not electroplatable.

18. The method according to claim 17, further comprises the step:
subjecting the multi-component interior trim part to an electroplating process such that the first component (5, 6) is coated with a metal layer a chromium layer, while the second component (5, 6) of the high temperature copolyester material remains substantially free of the metal layer.

19. The method according to claim 17,
wherein the first polymer material is a polymer blend of acrylonitrile-butadiene-styrene, ABS, and polycarbonate (PC).

20. An interior trim part for a vehicle, comprising:
a first region formed of a first, electroplatable polymer material and having an electroplated, decorative surface; and
a second region formed of a second, transparent polymer material that is connected to the first region by overmolding, and that is configured to guide light,
wherein the second polymer material is a high temperature copolyester material that exhibits improved chemical resistance relative to polycarbonate and a heat deflection temperature (HDT) at 1.8 MPa according to ISO 75 of at least 80° C.
